(19) United States
(12) Patent Application Publication
(10) Pub. No.: US 2020/0345056 A1
(43) Pub. Date: Nov. 5, 2020

(54) TUBE FEEDING COMPOSITION AND METHOD FOR PREPARATION THEREOF

(71) Applicant: Abbott Laboratories, Abbott Park, IL (US)

(72) Inventors: Gaurav PATEL, Gahanna, OH (US); Nalini PATEL, Plain City, OH (US); Normanella DEWILLE, Columbus, OH (US)

(21) Appl. No.: 16/964,111

(22) PCT Filed: Jan. 23, 2019
(86) PCT No.: PCT/US2019/014781

§ 371 Date: Jul. 22, 2020

Related U.S. Application Data
(60) Provisional application No. 62/622,350, filed on Jan. 26, 2018.

(51) Int. Cl. A23L 33/00; A23L 19/00; A23L 33/115; A23L 33/185; A23L 33/125; A23L 7/10; B65D 85/72

(52) U.S. Cl. CPC A23L 33/40; A23L 19/09; A23L 33/115; A23V 2002/00; A23L 33/125; A23L 7/10; B65D 85/72; A23L 33/185

(57) ABSTRACT

A tube feeding composition includes from about 20 wt % to about 40 wt % of fruit and vegetable, at least 3 wt % of whole grain, a source of protein, a source of carbohydrate, and a fat. The tube feeding composition has a desirable viscosity profile for tube feeding applications and may be manufactured using at least two homogenization steps.

### TECHNICAL FIELD

The present disclosure relates to nutritional products. More particularly, the present disclosure relates to tube feeding compositions that include fruit, vegetable, and whole grain, and that have a viscosity profile that enables the tube feeding compositions to be administered easily via a bolus feeding using a syringe.

### BACKGROUND

Conventional tube feeding compositions are often formulated as thin (low viscosity) liquids for administration through a feeding tube. Such tube feeding compositions typically avoid using whole food ingredients such as fruits, vegetables, and whole grains because such ingredients increase the viscosity of the tube feeding compositions, which makes the tube feeding compositions difficult to administer. So-called blenderized beverages, which are usually made in a home setting by blending together whole food ingredients such as fruits and vegetables, also typically have a thick consistency and are difficult to administer through a feeding tube. Furthermore, typical blenderized beverages are time consuming to prepare, inconvenient to transport/store, and have a very limited shelf-life (e.g., a few days with refrigeration).

### SUMMARY

Disclosed herein are tube feeding compositions, packaged tube feeding compositions, and methods of manufacturing tube feeding compositions.

In accordance with the present disclosure, a tube feeding composition is provided. The tube feeding composition comprises from about 20 wt % to about 40 wt % of fruit and vegetable and at least 3 wt % of whole grain. The composition also comprises a source of protein, a source of carbohydrate, and a source of fat, each of which are distinct from the fruit, the vegetable, and the whole grain. The tube feeding composition has a viscosity at 25° C. from about 50,000 cps to about 125,000 cps at a shear rate of 0.01 s⁻¹ and a viscosity at 25° C. from about 100 cps to about 400 cps at a shear rate of 25.1 s⁻¹.

In accordance with the present disclosure, a packaged tube feeding composition is provided. The packaged tube feeding composition comprises a sealed container having an interior volume and a tube feeding composition disposed within the interior volume of the container. The tube feeding composition comprises from about 20 wt % to about 40 wt % of fruit and vegetable and at least 3 wt % of whole grain. The composition also comprises a source of protein, a source of carbohydrate, and a source of fat, each of which are distinct from the fruit, the vegetable, and the whole grain. The tube feeding composition has a viscosity at 25° C. from about 50,000 cps to about 125,000 cps at a shear rate of 0.01 s⁻¹ and a viscosity at 25° C. from about 100 cps to about 400 cps at a shear rate of 25.1 s⁻¹.

In accordance with the present disclosure, a method of manufacturing a tube feeding composition is provided. The method comprises mixing together water, a source of protein, a source of carbohydrate, whole grain, a source of fat, fruit, and vegetable to form an initial tube feeding blend. The method further comprises homogenizing the initial tube feeding blend in a first homogenization step to form an intermediate tube feeding blend, and homogenizing the intermediate tube feeding blend in a second homogenization step to form a final tube feeding composition. The method further comprises packaging the final tube feeding composition. The final tube feeding composition has a viscosity at 25° C. from about 50,000 cps to about 125,000 cps at a shear rate of 0.01 s⁻¹ and a viscosity at 25° C. from about 100 cps to about 400 cps at a shear rate of 25.1 s⁻¹.

### DETAILED DESCRIPTION

Disclosed herein are tube feeding compositions, packaged tube feeding compositions, and methods of making tube feeding compositions. While the present disclosure describes certain embodiments of the compositions and methods in detail, the present disclosure is to be considered exemplary and is not intended to be limited to the disclosed embodiments. Also, certain elements or features of embodiments disclosed herein are not limited to a particular embodiment, but instead apply to all embodiments of the present disclosure.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

The tube feeding compositions, packaged tube feeding compositions, and corresponding methods of making the tube feeding compositions of the present disclosure can comprise, consist of, or consist essentially of any of the elements of the disclosure as described herein.

All percentages, parts, and ratios as used herein are by weight of the total composition, unless otherwise specified. All such weights as they pertain to listed ingredients are based on the active level and, therefore, do not include solvents, by-products, or other components that can be included in commercially available materials, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein can be performed in any order, unless otherwise specified or clearly implied to the contrary by the context in which the referenced combination is made.

The phrase “tube feeding composition” as used herein refers to a nutritional composition that is formulated to be administered to a subject's gastrointestinal system, other than by oral administration, via a feeding tube. Examples of feeding tube arrangements that can be used to administer the tube feeding composition include, but are not limited to, a gastric tube, a nasogastric tube, a jejunal tube, and a gastrojejunal tube.

The terms “puree” or “pureed” as used herein refers to a fruit, a vegetable, or a combination thereof that is mashed, pressed, blended, crushed, or otherwise broken down so that it has the texture of a semi-liquid or paste.

The term “concentrate” as used herein refers to a fruit juice or a vegetable juice where most (i.e., greater than 50 wt %) or all of the water is removed.

The term “toddler” as used herein refers to a human that is from 1 year old to less than 4 years old. The term “child” as used herein refers to a human that is from 4 years to 13 years of age. The term “adult” as used herein refers to a human that is older than 13 years old.

The phrase “whole grain” as used herein refers to a grain or grain ingredient that includes all the bran, germ, and endosperm of the original grain.

As indicated above, specific embodiments of the tube feeding compositions according to the present disclosure comprise from about 20 wt % to about 40 wt % of fruit and vegetable (based on the total weight of the tube feeding composition), at least 3 wt % of whole grain, or more specifically, at least about 6 wt % of the whole grain (based on the total weight of the tube feeding composition), and a source of protein, a source of carbohydrate, and a source of fat, each of which are distinct from the fruit, the vegetable, and the whole grain. By “distinct,” the present disclosure indicates that the fruit and vegetable and the whole grain are ingredients that are provided separately from the source of the protein, the source of the fat, and the source of the carbohydrate. The tube feeding compositions according to the present disclosure have a viscosity at 25° C. from about 50,000 cps to about 125,000 cps at a shear rate of 0.01 s⁻¹ and a viscosity at 25° C. from about 100 cps to about 400 cps at a shear rate of 25.1 s⁻¹.

It is surprisingly discovered that compositions of the present disclosure exhibit a viscosity profile that enables administration through a feeding tube. Using a significant amount of whole grain in combination with fruit and vegetable in a composition for tube feeding is thought to produce a composition that is too viscous for administration by feeding tube due to the fiber content and the interactions of the whole grain with protein, which can create curds. However, it is discovered that the tube feeding compositions of the present disclosure are shear thinning. Accordingly, the tube feeding compositions of the present disclosure have a relatively high viscosity at rest, which provides a stable product matrix that inhibits sedimentation and phase separation during storage, and a much lower viscosity when the tube feeding composition is exposed to shear forces, such as when the tube feeding composition is shaken prior to administration. Without being bound by any particular theory, it is believed that the two separate homogenization steps used to make the tube feeding compositions of the present disclosure help create the viscosity profile of the tube feeding compositions, along with the particular amounts of whole grain and fruits and vegetables utilized.

The tube feeding compositions of specific embodiments of the present disclosure are formulated to provide about 6 child servings or about 12 toddler servings of combined fruits and vegetables per liter of the tube feeding compositions. As used herein, a “child serving” of fruit or vegetable refers to a one-half cup serving of fruit or vegetable, in accord with the U.S. Department of Agriculture's (USDA) recommended serving amount of fruit or vegetable, while a “toddler serving” of fruit or vegetable refers to a one-fourth cup serving of fruit or vegetable, in accord with the USDA's recommended serving amount of fruit or vegetable. For example, a one cup serving of spinach is equivalent to 30 grams of spinach. A serving of 15 grams of spinach is equivalent to a one-half cup serving of spinach, or one child serving of vegetable in terms of spinach. Similarly, 7.5 grams of spinach is equivalent to a one-fourth cup serving of spinach, or one toddler serving of vegetable in terms of spinach. In addition, in specific embodiments, the tube feeding composition of the present disclosure is formulated to provide about 4 servings of whole grain per liter of the tube feeding composition. One child serving of whole grain is typically understood to be 16 grams of whole grain. One adult serving of whole grain is also typically understood to be 16 grams of whole grain. In specific embodiments, the composition provides up to about 4 servings of whole grain, or from about 1 to about 4 servings, or from about 2 to about 4 servings of grain per liter.

The tube feeding composition of specific embodiments of the present disclosure are formulated with sufficient kinds and amounts of nutrients to provide a sole, primary, or supplemental source of nutrition to the end user. In specific embodiments of the present disclosure, the tube feeding composition is nutritionally complete to allow the tube feeding composition to be the sole source of nutrition for a human. The phrase “nutritionally complete” as used herein refers to a composition that contains sufficient types and levels of macronutrients (protein, carbohydrate, and fat) and micronutrients to be sufficient to be a sole source of nutrition for the subject to whom the composition is administered. Subjects, including toddlers, children, or adults, can receive 100% of their nutritional requirements from such nutritionally complete compositions. In specific embodiments the nutritional requirements are determined according to the Food and Drug Administration's (FDA) publication “Food Labeling: Revision of the Nutrition and Supplement Facts” published on May 27, 2016.

In accordance with the present disclosure, the tube feeding composition comprises from about 20 wt % to about 40 wt % of fruit and vegetable, based on the total weight of the tube feeding composition. In embodiments of the present disclosure, the tube feeding composition comprises from about 20 wt % to about 35 wt % of fruit and vegetable, including from 20 wt % to 30 wt % of fruit and vegetable, from about 25 wt % to about 30 wt % of fruit and vegetable, from about 25 wt % to about 40 wt % of fruit and vegetable, and also including from about 25 wt % to about 35 wt % of fruit and vegetable, based on the total weight of the tube feeding composition. Specific embodiments of the composition are dairy-free, lactose and gluten free, and contain no artificial colors and/or flavors.

A variety of fruits and vegetables can be used in the tube feeding compositions disclosed herein. Exemplary fruits suitable for use in the tube feeding composition include, but are not limited to one or more of apple, banana, blueberry, mango, pear, strawberry, pineapple, avocado, peach, and lemon. Exemplary vegetables suitable for use in the tube feeding composition include, but are not limited to, one or more of squash, sweet potato, carrot, pumpkin, spinach, kale, broccoli, and zucchini. The fruits and vegetables that are used in the tube feeding composition are generally modified from their natural state to be in a state suitable for administration via tube feeding. For example, in specific embodiments, the fruits and vegetables are provided in the form of a puree, a concentrate, or a combination thereof. In certain embodiments, the fruits and/or vegetables used in the tube feeding composition can either be certified organic (e.g., USDA organic) or not certified organic, and also can be non-genetically modified (non-GMO) or genetically modified.

Specific embodiments comprise mango puree, pumpkin puree, spinach puree, banana puree, and carrot juice concentrate. In specific embodiments the spinach puree and banana puree are at a ratio of about 1:1. In specific embodiments the ratio of mango puree to either spinach puree or banana puree is about 2:1. In specific embodiments the ratio of mango puree to pumpkin puree is between about 2:1 and about 4:1.

Specific embodiments of the tube feeding composition include a fruit comprising at least one of an apple, banana, blueberry, mango, pear, strawberry, pineapple, avocado, peach, and lemon, and a vegetable comprising at least one of squash, sweet potato, carrot, pumpkin, spinach, kale, broccoli, and zucchini. Specific embodiments of the tube feeding composition comprise mango puree, banana puree, pumpkin puree, spinach puree, broccoli puree, and carrot juice concentrate. In specific embodiments of the tube feeding composition, the mango puree comprises from about 10 wt % to about 20 wt % of the fruit and vegetable, the banana puree comprises from about 30 wt % to about 40 wt % of the fruit and vegetable, the pumpkin puree comprises from about 5 wt % to about 10 wt % of fruit and vegetable, the spinach puree comprises from about 20 wt % to about 25 wt % of the fruit and vegetable, the broccoli puree comprises from about 8 wt % to about 12 wt % of fruit and vegetable, and the carrot juice concentrate comprises from about 1 wt % to about 5 wt % of the fruit and vegetable. In specific embodiments of the tube feeding composition, the fruit and vegetable comprise from about 2 wt % to about 8 wt % mango puree, from about 5 wt % to about 15 wt % banana puree, from about 0.75 wt % to about 4 wt % pumpkin puree, from about 4 wt % to about 10 wt % spinach puree, up to about 6 wt % broccoli puree, and from about 0.25 wt % to about 2 wt % carrot juice concentrate, each based on the total weight of the tube feeding composition.

In specific embodiments of the present disclosure, at least one of the fruit ingredients and/or the vegetable ingredients used to make the tube feeding composition, whether in puree form or concentrated juice form, is provided for use in a frozen state. In specific embodiments of the present disclosure, one or more of the fruit and/or vegetable ingredients used to make the tube feeding composition, whether in puree form or concentrated juice form, is provided for use in an aseptic state. In specific embodiments of the present disclosure, at least one of the fruit ingredients and/or the vegetable ingredients used to make the tube feeding composition is provided for use in a frozen state, and one or more of the fruit and vegetable ingredients is provided for use in an aseptic state.

In addition to the fruit and vegetable, specific embodiments of the tube feeding compositions of the present disclosure comprise at least 3.0 wt %, or more specifically, at least 6.0 wt % of whole grain, based on the total weight of the tube feeding composition. In embodiments of the present disclosure, the tube feeding composition comprises from about 3.0 wt % to about 20.0 wt % of whole grain, including from about 3.0 wt % to about 15.0 wt % of whole grain, from about 3.0 wt % to about 10.0 wt % of whole grain, and also including from about 3.0 wt % to about 8.0 wt % of whole grain, based on the total weight of the tube feeding composition.

A variety of whole grains, in specific embodiments, are used in the tube feeding compositions disclosed herein. Exemplary whole grains suitable for use in the tube feeding composition include, but are not limited to, rice, oats, amaranth, barley, buckwheat, millet, quinoa, sorghum, corn, wheat, and/or soy. The whole grains used in the tube feeding composition are generally modified from their natural state to be in a state suitable for administration via tube feeding. For example, in specific embodiments, the whole grains are milled and incorporated into the tube feeding composition in powder form. In certain embodiments, the whole grain used in the tube feeding composition is certified organic (e.g., USDA organic), or is not certified organic, and in specific embodiments is non-genetically modified (non-GMO), or is genetically modified.

In specific embodiments of the tube feeding composition, the whole grain comprises at least one of rice, oats, amaranth, barley, buckwheat, millet, quinoa, sorghum, corn, wheat, and soy. In specific embodiments of the tube feeding composition, the whole grain comprises brown rice. In specific embodiments of the present disclosure, the tube feeding composition comprises from about 3 wt % to about 20 wt % whole grain rice, based on the total weight of the tube feeding composition, including from about 3 wt % to about 15 wt % whole grain rice, from about 4 wt % to about 10 wt % whole grain rice, and also including from about 6 wt % to about 8 wt % whole grain rice, based on the total weight of the tube feeding composition.

Specific embodiments of the tube feeding composition disclosed herein also include a source of protein, a source of carbohydrate, and a source of fat. Generally, any source of protein, carbohydrate, and fat that is suitable for use in a nutritional product can also be suitable for use herein, provided that such macronutrients are also compatible with the other elements of the tube feeding composition as described herein. As mentioned above, the source of protein, the source of carbohydrate, and the source of fat are distinct from the fruit, the vegetable, and the whole grain, although the fruit, vegetable and whole grain can contribute to total amounts of protein, carbohydrate, and fat present in the tube feeding composition disclosed herein.

The amount of protein, carbohydrate, and fat in the tube feeding composition can be expressed in terms of weight percentage based on the total weight of the tube feeding composition. In specific embodiments of the present disclosure, including the protein, carbohydrate, and fat from the fruit and vegetables, the tube feeding composition comprises from about 1 wt % to about 8 wt % protein, from about 5 wt % to about 25 wt % carbohydrate, and from about 1 wt % to about 8 wt % fat. In specific embodiments of the present disclosure, the tube feeding composition comprises from about 2 wt % to about 6 wt % protein, from about 8 wt % to about 16 wt % carbohydrate, and from about 2 wt % to about 6 wt % fat. In embodiments of the present disclosure, the tube feeding composition comprises from about 2 wt % to about 4 wt % protein, from about 10 wt % to about 14 wt % carbohydrate, and from about 2 wt % to about 4 wt % fat.

Alternatively, the amount of protein, carbohydrate, and fat in the tube feeding composition can be expressed as a mass concentration. In specific embodiments of the present disclosure, including the protein, carbohydrate, and fat from the fruit and vegetables, the tube feeding composition comprises from about 15 mg/mL to about 65 mg/mL of protein, from about 85 mg/mL to about 175 mg/mL of carbohydrate, and from about 15 mg/mL to about 60 mg/mL of fat. In specific embodiments of the present disclosure, the tube feeding composition comprises from about 25 mg/mL to about 50 mg/mL of protein, from about 100 mg/mL to about 150 mg/mL of carbohydrate, and from about 25 mg/mL to about 50 mg/mL of fat. In specific embodiments of the present disclosure, the tube feeding composition comprises from about 30 mg/mL to about 40 mg/mL of protein, from about 125 mg/mL to about 135 mg/mL of carbohydrate, and from about 30 mg/mL to about 40 mg/mL of fat. In specific embodiments, the composition comprises about 9 grams of protein, about 31 grams of carbohydrate, about 2 grams of dietary fiber, about 9 grams of sugar, and about 9 grams of fat, and can contain docosahexanoic acid.

The amount of protein, carbohydrate, and fat in the tube feeding composition in specific embodiments is expressed in terms of the percentage of the total calories of the tube feeding composition contributed by each component. In specific embodiments of the present disclosure, including the protein, carbohydrate, and fat from the fruit and vegetables, the protein provides from about 10% to about 20% of the total calories of the tube feeding composition, the carbohydrate provides from about 40% to about 60% of the total calories of the tube feeding composition, and the fat provides from about 25% to about 40% of the total calories of the tube feeding composition. In specific embodiments of the present disclosure, the protein provides from about 10% to about 18% of the total calories of the tube feeding composition, the carbohydrate provides from about 45% to about 60% of the total calories of the tube feeding composition, and the fat provides from about 30% to about 38% of the total calories of the tube feeding composition. In specific embodiments of the present disclosure, the protein provides from about 12% to about 16% of the total calories of the tube feeding composition, the carbohydrate provides from about 48% to about 55% of the total calories of the tube feeding composition, and the fat provides from about 32% to about 36% of the total calories of the tube feeding composition. A listing of the dietary values for specific embodiments of the composition is provided in Table 1, below. The amounts and ranges for protein, carbohydrate and fat include the protein, carbohydrate, and fat from the fruit and vegetables.

TABLE 1

| | | | Range (Minimum and | |
|---|---|---|---|---|
| | | | Maximum Values of | |
| | | | Alternative | |
| DIETARY VALUES | Amount | | Embodiments) | |
| Serving Size | 237 | ml | | |
| Number of Fruit and | 5 toddler, child, | | 5-10 servings | |
| VegetableServings | or adult servings/L | | | |
| Product Density | 1.07 | g/ml | 1.08-1.1 | g/ml |
| Protein | 60.99 | g/L | 55.5-105 | g/L |
| Percent of Calories | 19.5% | | 15-35% | |
| from Protein | | | | |
| Fat | 39.59 | g/L | 27-46 | g/L |
| Percent of Calories | 28.5% | | 25-35% | |
| from Fat | | | | |
| Cholesterol | 0.00 | mg/L | | |
| Total Carbohydrate | 171.97 | g/L | 135-195 | g/L |
| Percent of Calories | 52.0% | | 45-65% | |
| from Carbohydrate | | | | |
| Total Fiber | 19 | g/L | 15-38 | g/L |
| Added Sugars | 8 | g/L | 0-25 | g/L |
| Ash | 11 | g/L | | |
| Calories | 1250 | kcal/L | 967-1576 | kcal/L |

Specific embodiments of the composition are made using organic, aseptic, and frozen fruit and vegetable purees and organic whole grain brown rice milk. Specific embodiments are made to be high in protein, containing about 13 grams per 8 fl. oz. serving, that can include plant-based proteins from soy and/or rice. Soy and rice proteins can comprise 100% of the protein of the composition. The composition also can be high in fiber, containing about 4.5 grams per 8 fl. oz. serving, can contain about 8 grams of whole grain per serving, and can be nutrient dense, with about 1.2 kcal/ml. Specific embodiments contain a fruit fiber powder and a vegetable fiber powder.

Specific embodiments comprise an organic, complete balanced nutritional tube feed product made with whole food ingredients. The product is designed to meet current nutritional guidelines for adults. Embodiments of specific compositions contain about 290 kcal, about 13 g of protein, about 9 g fat, about 0.75 cups of fruit and vegetable, and about 0.5 toddler, child, or adult serving of whole grain in 8 fl. oz. of product.

The fruit and vegetable and the whole grain in the tube feeding composition in specific embodiments contribute to the total amount of protein present in the tube feeding composition. The source of protein for use in the tube feeding composition in specific embodiments of the present disclosure can be a plant-based protein, an animal- based protein, or a combination thereof. The protein in specific embodiments is intact, partially hydrolyzed (i.e., a degree of hydrolysis of less than 20%), and/or extensively hydrolyzed (i.e., a degree of hydrolysis of at least 20%). The protein can also include at least one free amino acid.

Plant-based proteins suitable for use in the tube feeding composition of the present disclosure include, but are not limited to, soy protein (e.g., soy protein isolate), pea protein, rice protein (e.g., rice protein concentrate), and potato protein.

Animal-based proteins suitable for use in the tube feeding composition of the present disclosure include, but are not limited to, poultry protein (e.g., chicken protein), fish protein, ovine protein, porcine protein, and bovine protein. Milk-based proteins suitable for use in the tube feeding composition of the present disclosure include, but are not limited to, whole cow's milk, partially or completely defatted milk, milk protein concentrates, milk protein isolates, nonfat dry milk, condensed skim milk, whey protein concentrates, whey protein isolates, acid caseins, sodium caseinates, calcium caseinates, and potassium caseinates. The source of protein in specific embodiments is certified organic (e.g., USDA organic) or is not certified organic, and also in specific embodiments is non-genetically modified (non-GMO) or genetically modified. The tube feeding composition of the present disclosure in specific embodiments includes any individual source of protein or combination of the various sources of protein listed above.

In specific embodiments of the present disclosure, the tube feeding composition comprises a plant-based protein and an animal-based protein. In specific embodiments of the present disclosure, the tube feeding composition includes a plant-based protein comprising at least one of soy protein, pea protein, rice protein, and potato protein and an animal-based protein comprising at least one of poultry protein, fish protein, ovine protein, porcine protein, and bovine protein. In specific embodiments of the present disclosure, the tube feeding composition comprises soy protein, rice protein, and poultry protein. In specific embodiments of the present disclosure, the tube feeding composition comprises pea protein, rice protein, and poultry protein.

In addition, the source of protein in the tube feeding composition in specific embodiments includes one or more free amino acids. Free amino acids in specific embodiments used in the tube feeding composition disclosed herein include, but are not limited to, L-lysine, L-tryptophan, L-glutamine, L-tyrosine, L-methionine, L-cysteine, taurine, L-arginine, and L-carnitine.

The fruit and vegetable and the whole grain in specific embodiments of the tube feeding composition contribute to the total amount of carbohydrate present in the tube feeding composition. The source of carbohydrate for use in the tube feeding composition of the present disclosure in specific embodiments is simple, complex, or variations or combinations thereof. Sources of carbohydrate suitable for use in the tube feeding composition of the present disclosure include, but are not limited to, maltodextrin (e.g., rice maltodextrin, corn maltodextrin), hydrolyzed or modified starch or cornstarch, glucose polymers, corn syrup, corn syrup solids, sucrose, glucose, fructose, lactose, high fructose corn syrup, sugar alcohols (e.g., maltitol, erythritol, sorbitol), isomaltulose, sucromalt, pullulan, potato starch, fructooligosaccharides (FOS), and galactooligosaccharides (GOS). The source of carbohydrate in specific embodiments is certified organic (e.g., USDA organic) or is not certified organic, and in specific embodiments is non-genetically modified (non-GMO) or is genetically modified. The tube feeding composition of the present disclosure in specific embodiments includes any individual source of carbohydrate or a combination of the various sources of carbohydrate listed above. In specific embodiments, the carbohydrate sources are fruit and vegetable purees including organic banana puree, organic mango puree, organic spinach puree, organic pumpkin puree, and/or organic carrot juice concentrate, and rice sources such as organic rice maltodextrin and/or organic whole grain brown rice milk powder.

The fruit and vegetable and the whole grain in the tube feeding composition in specific embodiments contributes to the total amount of fat present in the tube feeding composition. In specific embodiments of the present disclosure, the tube feeding composition includes a source of fat that is not provided by the fruit, vegetable, or whole grain. The source of fat for use in specific embodiments of the tube feeding composition of the present disclosure is derived from various sources including, but not limited to, plants, animals, and/or a combination thereof. Sources of fat that are suitable for use in the tube feeding composition of the present disclosure include, but are not limited to, coconut oil, fractionated coconut oil, soy oil (e.g., high oleic soy oil), corn oil, olive oil, safflower oil (e.g., high oleic safflower oil), medium chain triglyceride oil (MCT oil), high gamma linolenic (GLA) safflower oil, sunflower oil (e.g., high oleic sunflower oil), palm oil, palm kernel oil, palm olein, canola oil (e.g., high oleic canola oil), marine oils, fish oils (e.g., tuna oil), algal oils, borage oil, cottonseed oil, fungal oils, eicosapentaenoic acid (EPA), docosahexaenoic acid (DHA), arachidonic acid (ARA), conjugated linoleic acid (CLA), alpha-linolenic acid, interesterified oils, transesterified oils, structured lipids, and combinations thereof. Generally, the source of fat used in the tube feeding composition provides fatty acids needed both as an energy source and for the healthy development of the toddler, child, or adult. The source of fat typically comprises triglycerides, although the source of fat can also comprise diglycerides, monoglycerides, phospholipids (e.g., lecithin) and/or free fatty acids. Fatty acids provided by the source of fat in the tube feeding composition of the present disclosure include, but are not limited to, capric acid, lauric acid, myristic acid, palmitic acid, palm itoleic acid, stearic acid, oleic acid, linoleic acid, alpha-linolenic acid, ARA, EPA, and DHA. Specific embodiments of the tube feeding composition of the present disclosure include any individual source of fat or combination of the various sources of fat listed above. Specific embodiments of the compositions are kosher, halal, and/or suitable for vegetarians and/or vegans. For example, specific embodiments do not contain chicken broth or tuna oil.

Specific embodiments of the tube feeding composition of the present disclosure have a caloric density tailored to the nutritional needs of the ultimate user. In specific embodiments of the present disclosure, the tube feeding composition has a caloric density of at least 0.85 kcal/m L. In specific embodiments of the present disclosure, the tube feeding composition has a caloric density from about 0.85 kcal/mL to about 1.4 kcal/mL, including from about 0.85 kcal/mL to about 1.25 kcal/mL, from about 0.9 kcal/m L to about 1.2 kcal/m L, from about 0.95 kcal/m L to about 1.1 kcal/m L, and also including from about 1 kcal/mL to about 1.05 kcal/mL.

Specific embodiments of the tube feeding composition of the present disclosure are formulated to have a neutral or near neutral pH. In embodiments of the present disclosure, the tube feeding composition has a pH from about 6.4 to about 7.5, including from about 6.5 to about 7.4, from about 6.6 to about 7.3, and also including from about 6.7 to about 7.1.

The tube feeding composition of the present disclosure can have a solids content from about 15 wt % to about 30 wt % based on the total weight of the tube feeding composition. In embodiments of the present disclosure, the tube feeding composition has a solids content from about 15 wt % to about 25 wt % based on the total weight of the tube feeding composition. In embodiments of the present disclosure, the tube feeding composition has a solids content from about 20 wt % to about 25 wt % based on the total weight of the tube feeding composition. The phrase “solids content” as used herein refers to the amount of the tube feeding composition that is not liquid. The tube feeding composition can be formulated to have a variety of product densities, but most typically has a density of at least 1.03 g/mL, including from about 1.03 g/mL to about 1.1 g/mL, from about 1.04 g/mL to about 1.08 g/mL, and also including from about 1.05 g/mL to about 1.0 g/m L.

As previously mentioned, specific embodiments of the tube feeding composition according to the present disclosure have a viscosity at 25° C. from about 50,000 cps to about 125,000 cps at a shear rate of 0.01 s⁻¹ and a viscosity at 25° C. from about 100 cps to about 400 cps at a shear rate of 25.1 s⁻¹, and a viscosity at 25° C. from about 150 cps to about 250 cps at a shear rate of 39.8 s⁻¹. In specific embodiments of the present disclosure, the tube feeding composition has a viscosity at 25° C. from about 65,000 cps to about 110,000 cps at a shear rate of 0.01 s⁻¹ and a viscosity at 25° C. from about 175 cps to about 325 cps at a shear rate of 25.1 s⁻¹. In specific embodiments of the present disclosure, the tube feeding composition has a viscosity at 25° C. from about 65,000 cps to about 105,000 cps at a shear rate of 0.01 s⁻¹ and a viscosity at 25° C. from about 175 cps to about 275 cps at a shear rate of 25.1 s⁻¹. In specific embodiments of the present disclosure, the tube feeding composition has a viscosity at 25° C. from about 65,000 cps to about 110,000 cps at a shear rate of 0.01 s⁻¹ and a viscosity at 25° C. from about 155 cps to about 200 cps at a shear rate of 39.8 s⁻¹. In specific embodiments of the present disclosure, the tube feeding composition has a viscosity at 25° C. from about 65,000 cps to about 105,000 cps at a shear rate of 0.01 s⁻¹ and a viscosity at 25° C. from about 160 cps to about 190 cps at a shear rate of 39.8 s⁻¹. The viscosity profile of specific embodiments of the tube feeding composition provides a stable product matrix that inhibits sedimentation and phase separation during storage, which allows the tube feeding composition to be free of stabilizers conventionally used in nutritional compositions to prevent sedimentation and phase separation (e.g., carrageenan, carboxy methylcellulose, xanthan gum, gellan gum). Therefore, specific embodiment do not contain any stabilizer. The viscosity profile of specific embodiments of the tube feeding composition disclosed herein also permits administration via a feeding tube because the high viscosity of the composition when at rest lowers to a viscosity that is acceptable for administration via a feeding tube when the tube feeding composition is exposed to shear forces, such as when the tube feeding composition is shaken prior to administration.

The viscosity of the tube feeding composition can be measured using a TA Instruments Discovery HR-3 rheometer under flow sweep mode with a shear rate from 0.01 s⁻¹ to 100 s⁻¹.

In specific embodiments of the present disclosure, solids in the tube feeding composition have an average particle size from about 10 μm to about 70 μm. In specific embodiments of the present disclosure, solids in the tube feeding composition have an average particle size from about 10 μm to about 65 μm, including from about 15 μm to about 60 μm, from about 20 μm to about 55 μm, and also including from about 20 μm to about 50 μm. In specific embodiments of the present disclosure, solids in the tube feeding composition have a median particle size from about 5 μm to about 50 μm. In specific embodiments of the present disclosure, solids in the tube feeding composition have a mean particle size of about 5 μm to about 45 μm, including from about 10 μm to about 40 μm, and also including from about 14 μm to about 35 μm.

In addition to the average particle size and the median particle size, the tube feeding composition of the present disclosure can also be characterized in terms of dl 0 value, d50 value, and d90 value. The d10 value refers to the particle size value of a sample of which 10% of the total particles in the sample are less than. In other words, if the d10 value is 5 μm, then 10% of the particles in the sample are less than 5 μm. The d50 value refers to the particle size value of a sample of which 50% of the total particles in the sample are less than or greater than. The d90 value refers to the particle size value of a sample of which 90% of the total particles in the sample are less than. In embodiments of the present disclosure, the tube feeding composition has a d10 value of 0.1 μm to 15 μm, including from 0.2 μm to 10 μm, from 0.25 μm to 5 μm, and also including from 0.3 μm to 3.75 μm. In embodiments of the present disclosure, solids of the tube feeding composition have a d50 value of 3 μm to 55 μm, including from 5 μm to 50 μm, from 10 μm to 45 μm, and also including from 14 μm to 35 μm. In embodiments of the present disclosure, solids of the tube feeding composition have a d90 value of 25 μm to 200 μm, including from 40 μm to 150 μm, from 45 μm to 130 μm, and also including from 50 μm to 115 μm.

The particle size of the tube feeding composition in specific embodiments is obtained using a Beckman Coulter LS 13 320 Laser Diffraction Particle Size Analyzer using the Aqueous Liquid Module.

In specific embodiments of the present disclosure, the tube feeding composition comprises vitamins and minerals. In specific embodiments of the present disclosure, the tube feeding composition comprises at least one of vitamin A, vitamin D, vitamin E, vitamin K, thiamine, riboflavin, pyridoxine, vitamin B₁₂, niacin, folic acid, pantothenic acid, biotin, vitamin C, choline, and inositol. In specific embodiments of the present disclosure, the tube feeding composition comprises at least one of calcium, phosphorus, magnesium, iron, zinc, manganese, copper, sodium, potassium, molybdenum, chromium, selenium, chloride, and iodine.

Specific embodiments of the tube feeding composition disclosed herein include a variety of optional ingredients that modify the physical, chemical, or processing characteristics of the tube feeding composition, or merely serve as additional nutritional component. In specific embodiments of the present disclosure, the tube feed composition further comprises at least one of a prebiotic, a probiotic, a nucleotide, a nucleoside, and a carotenoid (e.g., lutein, beta-carotene, lycopene, zeaxanthin).

In specific embodiments, the tube feeding composition is administered to a subject by bolus feeding. Bolus feeding is a type of feeding method that uses a syringe to deliver a composition through a feeding tube. The subject can be administered multiple boluses of the tube feeding composition per day. In specific embodiments, one bolus of the tube feeding composition corresponds to one toddler, child, or adult serving of the tube feeding composition as described above. In specific embodiments, a first bolus of the tube feeding composition is administered to the subject at a time of day corresponding to a typical breakfast time. In specific embodiments, a second bolus of the tube feeding composition is administered to the subject at a second time of the day corresponding to a typical lunch time. In specific embodiments, a third bolus of the tube feeding composition is administered to the subject at a third time of the day corresponding to a typical dinner time. In specific embodiments, further boluses of the tube feeding composition are administered to the subject between the breakfast time and the lunch time, between the lunch time and dinner time, or after the dinner time. In specific embodiments the bolus feedings correlate with a subject's 1, 2, 3, or more feeding times. In specific embodiments the method of administration of boluses comprises administration at determined intervals, such as approximately every 4 hours or approximately every 8 hours.

In specific embodiments of the present disclosure, the tube feeding composition is dairy free, lactose free, galactose free, gluten free, and does not contain any artificial preservatives, colors, or flavors.

In one aspect of the present disclosure, a packaged tube feeding composition is provided. In specific embodiments, the packaged tube feeding composition includes a sealed container having an interior volume and a tube feeding composition disposed within the interior volume of the container. Specific embodiments of the tube feeding composition comprise from about 20 wt % to about 40 wt % of fruit and vegetable and at least about 3 wt % of a whole grain, or more specifically at least about 6 wt % of the whole grain. Specific embodiments of the tube feeding composition also comprise a source of carbohydrate, and a source of fat. Specific embodiments of the tube feeding composition have a viscosity at 25° C. from about 50,000 cps to about 125,000 cps at a shear rate of 0.01 s⁻¹ and a viscosity at 25° C. from about 100 cps to about 400 cps at a shear rate of 25.1 s⁻¹. Any of the previously described embodiments or features of the tube feeding composition can be included in the packaged tube feeding composition.

Specific embodiments of the composition are packaged and provided as a single toddler, child, or adult serving. In certain embodiments, multiple (e.g., two or more) single serving packages of the tube feeding composition are packaged together in a carton. In specific embodiments, the sealed container of the packaged tube feeding composition is a conventional sealed container known to one of skill in the art. Suitable sealed containers are available from Tetra Pak (Pully, Switzerland) and SIG Combibloc Inc. (Neuhausen am Rheinfall, Switzerland). In specific embodiments, the sealed container is reclosable after being opened. In specific embodiments, the sealed container of the packaged tube feeding composition includes a reclosable closure, such as a threaded cap, that allows the sealed container to be closed after opening the container to access the tube feeding composition.

In one aspect of the present disclosure a method of making a tube feeding composition is provided. Any of the previously described embodiments or features of the tube feeding composition can be made in accordance with the method disclosed herein. The method of making a tube feeding composition of the present disclosure, in specific embodiments, includes mixing together water, a source of protein, a source of carbohydrate, a source of whole grain, a source of fat, a fruit, and a vegetable to form an initial tube feeding blend. In specific embodiments, the initial tube feeding blend is homogenized in a first homogenization step to form an intermediate tube feeding blend. In specific embodiments, the intermediate tube feeding blend is homogenized in a second homogenization step to form a final tube feeding composition. In specific embodiments, after forming the final tube feeding composition, the final tube feeding composition is packaged.

In specific embodiments of the present disclosure, the method of making a tube feeding composition includes mixing together water, a source of protein, a source of carbohydrate, a source of whole grain, a source of fat, a fruit, and a vegetable at a temperature of no more than about 110° F. to form an initial tube feeding blend. In specific embodiments, the foregoing ingredients are mixed together in the order listed. In specific embodiments, vitamins and minerals are added as the last ingredients to form the initial tube feeding blend.

In specific embodiments of the present disclosure, the initial tube feeding blend is homogenized in a first homogenization step to form an intermediate tube feeding blend. In specific embodiments, the first homogenization step is performed using a two-stage homogenizer that applies a first-stage pressure from about 1,500 psi to about 3,500 psi, or from about 2000 psi to about 3000 psi, which in specific embodiments is about 2,500 psi, and applies a second-stage pressure from about 250 psi to about 750 psi, or from about 400 psi to about 600 psi, that in specific embodiments is about 500 psi. In specific embodiments, the intermediate tube feeding blend is cooled to a temperature from about 34° F. to about 45° F. and transferred to a holding tank, where the intermediate tube feeding blend is stored prior to further processing for up to about 72 hours at a temperature from about 34° F. to about 45° F.

In specific embodiments of the present disclosure, the intermediate tube feeding blend is aseptically processed. In other words, the intermediate tube feeding blend is subjected to a sterilization process prior to packaging. In specific embodiments of the present disclosure, the intermediate tube feeding blend is aseptically processed using a high temperature short time (HTST) processing step (e.g., from about 160° F. to about 175° F. for from about 15 to about 30 seconds) or an ultra-high temperature (UHT) processing step (e.g., at least about 287° F. for about 5 seconds) to sterilize the intermediate tube feeding blend.

In specific embodiments, the intermediate tube feeding blend, which can be a sterilized intermediate tube feeding blend, is homogenized in a second homogenization step to form the final tube feeding composition. In specific embodiments, the second homogenization step is performed using a two-stage homogenizer that applies a first-stage pressure from about 1,500 psi to about 3,500 psi, or from about 2000 psi to about 3000 psi, such as about 2,500 psi, and applies a second-stage pressure from about 250 psi to about 750 psi, or from about 400 psi to about 600 psi, such as about 500 psi. In specific embodiments, the intermediate tube feeding blend is cooled to a temperature from about 160° F. to about 180° F. prior to undergoing the second homogenization step. In specific embodiments, the final tube feeding composition is cooled to a temperature from about 65° F. to about 75° F. and transferred to an aseptic holding tank, where the final tube feeding composition is stored prior to packaging at a temperature from about 60° F. to about 80° F.

In specific embodiments, the final tube feeding composition is packaged. In specific embodiments, the container in which the final tube feeding composition is packaged is sterilized prior to filling the container with the final tube feeding composition. For example, the container is sterilized by the application of hydrogen peroxide or other suitable disinfectant to the inside surface of the container. The hydrogen peroxide or other disinfectant is applied via an atomized mist. To complete the packaging step, in specific embodiments, the sterilized container is filled with the sterilized final tube feeding composition under aseptic processing conditions and is then sealed with a sterilized closure.

In specific embodiments, the tube feeding composition is packaged using a retort processing method. In specific embodiments, the retort processing method includes filling a container with the final tube feeding composition, sealing the container, and then subjecting the sealed, filled container to a heat sterilization step to form a retort packaged tube feeding composition.

A packaged tube feeding composition of the present disclosure is shelf-stable. In other words, the packaged tube feeding composition of the present disclosure can be stored at room temperature (e.g., from about 20° C. to about 25° C.) without spoiling for an extended period of time. In embodiments of the present disclosure, the packaged tube feeding composition is shelf-stable for at least about 3 months, including at least about 6 months, at least about 12 months, from about 3 months to about 18 months, from about 6 months to about 15 months, and also including from about 12 months to about 15 months. Such shelf stability renders the packaged tube feeding composition portable and convenient to use because refrigeration is not required.

### EXAMPLES

The examples that follow illustrate embodiments of the tube feeding compositions described herein. The examples are given solely for the purpose of illustration and are not to be construed as limiting of the present disclosure, as many variations thereof are possible without departing from the spirit and scope of the present disclosure.

Composition Ingredients

Specific examples of the current invention comprise five samples (Sample A, Sample B, Sample C, Sample D, and Sample E) of a tube feeding composition.

Samples A and B comprise water, tri-calcium phosphate, ferrous sulfate, rice protein concentrate, pea protein concentrate, chicken broth protein, whole grain brown rice, rice maltodextrin, mango puree, pumpkin puree, banana puree, carrot juice concentrate, spinach puree, broccoli puree, canola oil, high oleic safflower oil, tuna oil, soy lecithin, choline chloride, zinc sulfate, L-carnitine, ascorbic acid, potassium iodide, and a potassium hydroxide aqueous solution.

Sample C comprises water, tri-calcium phosphate, ferrous sulfate, rice protein concentrate, pea protein concentrate, chicken broth protein, whole grain brown rice, rice maltodextrin, mango puree, pumpkin puree, banana puree, carrot juice concentrate, spinach puree, broccoli puree, soy oil, high oleic safflower oil, tuna oil, soy lecithin, L-lysine, potassium chloride, choline chloride, zinc sulfate, L-carnitine, ascorbic acid, potassium iodide, and a potassium hydroxide aqueous solution.

Sample D comprises water, tri-calcium phosphate, potassium chloride, choline chloride, ferrous sulfate, rice protein concentrate, soy protein isolate, chicken protein, whole grain brown rice, rice maltodextrins, mango puree, pumpkin puree, banana puree, carrot juice concentrate, spinach puree, broccoli puree, soy oil, high oleic safflower oil, tuna oil, soy lecithin, L-lysine, zinc sulfate, L-carnitine, ascorbic acid, potassium iodide, and a potassium hydroxide aqueous solution.

Sample E comprises water, tri-calcium phosphate, potassium chloride, choline chloride, magnesium phosphate dibasic, organic rice protein concentrate, isolated soy protein IP, fructooligosaccharides, organic whole grain brown rice, organic rice maltodextrins 18 dextrose equivalent (DE), organic mango puree, organic pumpkin puree, organic spinach puree, organic seedless banana puree, organic carrot juice concentrate, non-GMA soy oil, non-GMO high oleic safflower oil, IP soy lecithin, L-lysine, L-carnitine, ascorbic acid, and a potassium hydroxide aqueous solution.

The compositions also comprise a premix of minerals, including calcium, chloride, iodine, iron, phosphorus, potassium, zinc, magnesium, manganese, molybdenum, chromium, copper, selenium, and sodium. Minerals in the premix can combine to provide at least a portion of the mineral forms of the ingredients listed for Samples A-E, above. For example, Sample E contains magnesium phosphate dibasic, while the premix of minerals contains magnesium and phosphorus. A premix can be added to ensure that compositions provide minerals to meet nutritional requirements.

The compositions also comprise a premix of vitamins and nutrients, including vitamin A, vitamin D, vitamin E, vitamin K, vitamin B1, vitamin B2, vitamin B6, vitamin B12, vitamin C, folate, folic acid, pantothenic acid, biotin, niacin, taurine, m-inositol, and beta carotene.

Syringe Testing

Tests evaluate the suitability for administering tube feeding compositions of the present disclosure via bolus feeding, and provide data for a comparison of Sample A, Sample B, and Sample C to commercially available products. The commercially available products are Compleat® tube feeding formula from Nestle Health Science, Compleat® Pediatric tube feeding formula from Nestle Health Science, Real Food Blends Orange Chicken, Carrots and Brown Rice tube feeding formula (RealFood OC-C-B) from Real Food Blends (Chesterton, Ind.), and Real Food Blends Quinoa, Kale and Hemp tube feeding formula (RealFood Q-K-H) from Real Food Blends (Chesterton, Ind.).

The Compleat® tube feeding formula includes the following ingredients: water, brown rice syrup, fruit and vegetable (tomato paste, peach puree, green been powder, carrot powder, cranberry juice concentrate), milk protein concentrate, canola oil, and less than about 2% of dehydrated chicken powder, vitamins and minerals, pea protein isolate, pea fiber, pea powder, gum acacia, fructooligosaccharides, salt, and inulin. The Compleat® Pediatric tube feeding formula includes the following ingredients: water, brown rice syrup, fruit and vegetable (tomato paste, green bean powder, peach puree, carrot powder, cranberry juice concentrate), and less than 2% of dehydrated chicken powder, canola oil, milk protein concentrate, pea protein isolate, vitamins and minerals, pea powder, medium chain triglycerides, pea fiber, gum acacia, fructooligosaccharides, inulin, and salt. The RealFood OC-C-B tube feeding formula includes the following ingredients: orange juice, cooked chicken, carrots, brown rice, grapeseed oil, water, ginger, and roasted sunflower seeds. The RealFood Q-K-H tube feeding formula includes the following ingredients: water, kale, grape juice concentrate, hemp powder, extra virgin olive oil, quinoa, and cinnamon.

A syringe test is conducted on each of the products (i.e., Sample A, Sample B, Sample C, Compleat® tube feeding formula, Compleat® Pediatric tube feeding formula, RealFood OC-C-B tube feeding formula, and RealFood Q-K-H tube feeding formula). The syringe testing is carried out using a 14 fr feeding tube and a 60 cm³ syringe having an ENFit^{TM} connector, both with and without the plunger. When performing the test without the plunger (i.e., gravity testing), the syringe is connected to the feeding tube and approximately 50 cm³ of sample is introduced into the syringe and allowed to flow through the feeding tube by gravity. When performing the test with the plunger, approximately 50 cm³ of sample is drawn into the syringe, the syringe is connected to the feeding tube, and then the plunger is depressed to push the formula into the feeding tube. Samples A, B, and C are tested under four scenarios: cold (e.g., less than 5° C.) unshaken; cold shaken; room temperature (e.g., 20° C. to 25° C.) unshaken; and room temperature shaken. The Compleat® tube feeding formula and the Compleat® Pediatric tube feeding formula are tested at room temperature, shaken. The RealFood OC-C-B and RealFood Q-K-H tube feeding formulas are tested at room temperature unshaken.

Under the cold unshaken condition, Samples A, B, and C all flow easily, with an acceptable amount of pressure applied to the plunger of the syringe. During gravity testing using the syringe without the plunger, Samples A and C flow easily, but slow to a drip during testing. Sample B does not flow easily during gravity testing.

Under the cold shaken condition, Samples A, B, and C all flow easily with an acceptable amount of pressure applied to the plunger of the syringe. Samples A, B, and C all flow easily during gravity testing using the syringe without the plunger.

Under the room temperature unshaken condition, Samples A, B, and C all flow easily, with an acceptable amount of pressure applied to the plunger of the syringe. During gravity testing using the syringe without the plunger, Sample C flows freely, while Samples A and B do not flow freely.

Under the room temperature shaken condition, Samples A, B, and C all flow easily with an acceptable amount of pressure applied to the plunger of the syringe. Samples A, B, and C all flow freely during gravity testing using the syringe without the plunger.

The sample of Compleat® Pediatric tube feeding formula appears less viscous than Samples A, B, and C. The sample of Compleat® Pediatric tube feeding formula flows easily using the plunger in the syringe and requires less pressure on the plunger as compared to Samples A, B, and C. During gravity testing using the syringe without the plunger, the sample of Compleat® Pediatric tube feeding formula flows freely and is faster than the gravity flow of Samples A, B, and C.

The sample of Compleat® tube feeding formula appears less viscous than Samples A, B, and C. The sample of Compleat® tube feeding formula flows easily using the plunger in the syringe and requires slightly more pressure on the plunger as compared to the sample of Compleat® Pediatric tube feeding formula, but less pressure on the plunger as compared to Samples A, B, and C. During gravity testing using the syringe without the plunger, it is discovered that the sample of Compleat® tube feeding formula flows freely and is faster than the gravity flow of Samples A, B, and C.

The samples of the RealFood OC-C-B and Q-K-H tube feeding formula appear much more viscous compared to Samples A, B, and C, and each has a pudding-like consistency. A large amount of pressure is applied on the plunger of the syringe to initiate flow of both the RealFood OC-C-B and Q-K-H tube feeding formulas. During gravity testing using the syringe without the plunger, the samples of the RealFood OC-C-B and Q-K-H tube feeding formula do not flow.

The results of the syringe test indicate that Samples A, B, and C of the present disclosure are suitable for administration by bolus feeding with a syringe, especially when the Samples are shaken and/or are at room temperature. Compleat® tube feeding formula and Compleat® Pediatric tube feeding formula also move through syringe easily, though these two compositions do not include the whole food ingredients of Samples A, B, and C. On the other hand, RealFood OC-C-B tube feeding formula and RealFood Q-K-H tube feeding formula, which do contain some whole food ingredients, prove more viscous than Samples A, B, or C, which makes these two compositions problematic for tube feeding, due to the required pressure for overcoming the high viscosities.

Additional Testing of Viscosities

Viscosity tests are conducted to evaluate the viscosities of the tube feeding compositions of the present disclosure, and compare the results to the viscosities of commercially available products.

Viscosity measurements are performed on four samples of tube feeding compositions of the present disclosure (Samples A-D). The shear viscosity of each sample is measured by a TA Instruments Discovery HR-3 rheometer under flow sweep mode with a shear rate from 0.01 s⁻¹ to 100 s⁻¹. A Peltier concentric cylinder and cup-rotor geometryiss are employed for shearing application and temperature control. The size of each sample tested is about 22.5 mL. Viscosity measurements are also performed on the Compleat® tube feeding formula and the Compleat® Pediatric tube feeding formula. In addition, viscosity measurements are performed on a sample of Real Food Blends Orange Chicken, Carrots & Brown Rice tube feeding formula (RealFood OC-C-B), a sample of Real Food Blends Quinoa, Kale & Hemp tube feeding formula (RealFood Q-K-H), and a sample of Liquid Hope® tube feeding formula (LiqHope) from Nutritional Medicinals, LLC (Centerville, Ohio). The viscosity of each product is determined at 25° C., using shear rates of 0.01 s⁻¹, 25.1 s⁻¹, and 39.8 s⁻¹. The results of the viscosity measurements are shown in Table 2.

TABLE 2

| | Viscosity, 25° C. | | |
|---|---|---|---|
| Sample | at 0.01 s⁻¹ | at 25.1 s⁻¹ | at 39.8 s⁻¹ |
| Sample A | 90,434 cps | 251 cps | 180 cps |
| Sample B | 69,287 cps | 219 cps | 161 cps |
| Sample C | 104,300 cps | 180 cps | 127 cps |
| Sample D | 91,220 cps | 227 cps | 165 cps |
| Sample E | 86,720 cps | 294 cps | 218 cps |
| Compleat ® | 57,460 cps | 61 cps | 47 cps |
| Compleat ®-Ped | 90,670 cps | 75 cps | 57 cps |
| Complete ® - | 275,740 | 1,339 cps | 992 cps |
| Upgraded | | | |
| RealFood OC-C-B | >9,532,540 cps | 4,962 cps | 3,442 cps |
| RealFood Q-K-H | >7,994,300 cps | 3,310 cps | 2,261 cps |
| LiqHope | >1,044,880 cps | 881 cps | 643 cps |

As seen from Table 2, Samples A, B, C, D, and E of the present disclosure have viscosities at 25.1 s⁻¹ and 39.8 s⁻¹ that are between the thin viscosities of the Compleat® and Compleat®-Ped products and the thick viscosities of the Compleat® upgraded formula which contains additional fruit and vegetable, RealFood and LiqHope products. The viscosity profiles of Samples A, B, C, D, and E allow flexibility in choosing the tube feeding apparatus/tubes, as well as easy flow through the syringe during bolus feeding. Products having viscosities that are too thin, such as the Compleat® and Compleat®-Ped products, can be perceived as being synthetic and not made with whole food ingredients. On the other hand, products having viscosities that are too thick, such as the Compleat® upgraded formula, RealFood and LiqHope products, can be problematic (e.g., difficult to administer) for tube feeding application.

While the present disclosure is illustrated by the description of embodiments thereof, and while the embodiments are described in detail, it is not the intention of the applicants to restrict or in any way limit the scope of the appended claims to such detail. Additional advantages and modifications will readily appear to those skilled in the art. Therefore, the present disclosure, in its broader aspects, is not limited to the specific details, the representative compositions and processes, and illustrative examples shown and described. Accordingly, departures can be made from such details without departing from the spirit or scope of the present disclosure.

1. A tube feeding composition comprising:
from about 20 wt % to about 40 wt % of fruit and vegetable;
at least 3 wt % of whole grain; and
a source of protein, a source of carbohydrate, and a source of fat, each of which are distinct from the fruit, the vegetable, and the whole grain; and
wherein the tube feeding composition has a viscosity at 25° C. from about 50,000 cps to about 125,000 cps at a shear rate of 0.01 s⁻¹ and a viscosity at 25° C. from about 100 cps to about 400 cps at a shear rate of 25.1 s⁻¹.

2. The tube feeding composition of claim 1, wherein:
the fruit comprises at least one of apple, banana, blueberry, mango, pear, strawberry, pineapple, avocado, peach, and lemon; and
the vegetable comprises at least one of squash, sweet potato, carrot, pumpkin, spinach, kale, broccoli, and zucchini.

3. The tube feeding composition of claim 1, wherein the whole grain comprises at least one of rice, oats, amaranth, barley, buckwheat, millet, quinoa, sorghum, corn, wheat, and soy.

4. The tube feeding composition of claim 1, wherein the source of protein comprises a plant-based protein and an animal-based protein.

5. The tube feeding composition of claim 4, wherein:
the plant-based protein comprises at least one of soy protein, pea protein, rice protein, and potato protein; and
the animal-based protein comprises at least one of poultry protein, fish protein, ovine protein, porcine protein, and bovine protein.

6. The tube feeding composition of claim 1, wherein the tube feeding composition has a viscosity at 25° C. from about 65,000 cps to about 110,000 cps at a shear rate of 0.01 s⁻¹ and a viscosity at 25° C. from about 175 cps to about 325 cps at a shear rate of 25.1 s⁻¹.

7. The tube feeding composition of claim 1, wherein the tube feeding composition has a caloric density from about 0.85 kcal/mL to about 1.4 kcal/mL.

8. The tube feeding composition of claim 1, wherein the tube feeding composition has a pH from about 6.4 to about 7.5.

9. The tube feeding composition of claim 1, wherein the tube feeding composition is nutritionally complete to allow the tube feeding composition to be the sole source of nutrition for a human.

10. A packaged tube feeding composition comprising:
a sealed container having an interior volume;
a tube feeding composition disposed within the interior volume of the container, the tube feeding composition comprising:
from about 20 wt % to about 40 wt % of fruit and vegetable;
at least 3 wt % of whole grain; and
a source of protein, a source of carbohydrate, and a source of fat, each of which are distinct from the fruit, the vegetable, and the whole grain; and
wherein the tube feeding composition has a viscosity at 25° C. from about 50,000 cps to about 125,000 cps at a shear rate of 0.01 s⁻¹ and a viscosity at 25° C. from about 100 cps to about 400 cps at a shear rate of 25.1 s⁻¹.

11. The packaged tube feeding composition of claim 10, wherein:
the fruit comprises at least one of apple, banana, blueberry, mango, pear, strawberry, pineapple; avocado, peach, and lemon; and
the vegetable comprises at least one of squash, sweet potato, carrot, pumpkin, spinach, kale, broccoli, and zucchini.

12. The packaged tube feeding composition of claim 10, wherein the whole grain comprises at least one of rice, oats, amaranth, barley, buckwheat, millet, quinoa, sorghum, corn, wheat, and soy.

13. The packaged tube feeding composition of claim 10, wherein the source of protein comprises a plant-based protein and an animal-based protein.

14. The packaged tube feeding composition of claim 13, wherein:
the plant-based protein comprises at least one of soy protein, pea protein, rice protein, and potato protein; and
the animal-based protein comprises at least one of poultry protein, fish protein, ovine protein, porcine protein, and bovine protein.

15. The packaged tube feeding composition of claim 10, wherein the tube feeding composition has a viscosity at 25° C. from about 65,000 cps to about 110,000 cps at a shear rate of 0.01 s⁻¹ and a viscosity at 25° C. from about 175 cps to about 325 cps at a shear rate of 25.1 s⁻¹.

16. The packaged tube feeding composition of claim 10, wherein the tube feeding composition has a caloric density from about 0.85 kcal/mL to about 1.4 kcal/mL.

17. The packaged tube feeding composition of claim 10, wherein the tube feeding composition has a pH from about 6.4 to about 7.5.

18. The packaged tube feeding composition of claim 10, wherein the packaged tube feeding composition is shelf-stable for at least 12 months.

19. The composition of claim 1, wherein the composition comprises at least 6 wt % of the whole grain.

20. A method of manufacturing a tube feeding composition comprising:
mixing together water, a source of protein, a source of carbohydrate, whole grain, a source of fat, fruit, and vegetable to form an initial tube feeding blend;
homogenizing the initial tube feeding blend in a first homogenization step to form an intermediate tube feeding blend;
homogenizing the intermediate tube feeding blend in a second homogenization step to form a final tube feeding composition; and
packaging the final tube feeding composition; and
wherein the final tube feeding composition has a viscosity at 25° C. from about 50,000 cps to about 125,000 cps at a shear rate of 0.01 s⁻¹ and a viscosity at 25° C. from about 100 cps to about 400 cps at a shear rate of 25.1 s⁻¹.
